(19) United States
(12) Patent Application Publication
(10) Pub. No.: US 2005/0235794 A1
(43) Pub. Date: Oct. 27, 2005

(54) Structure of cutting guide for table saw

(75) Inventors: George Ku, Dali City (TW); Eric Lo, Dali City (TW)

Correspondence Address: BIRCH STEWART KOLASCH & BIRCH, PO BOX 747, FALLS CHURCH, VA, 22040-0747, US

(73) Assignee: REXON INDUSTRIAL CORP., LTD.

(21) Appl. No.: 11/023,514

(22) Filed: Dec. 29, 2004

(30) Foreign Application Priority Data
Apr. 23, 2004 (TW) 093206255

(51) Int. Cl. B26D 7/06

(52) U.S. Cl. 83/522.11; 83/477.2

(57) ABSTRACT

The invention discloses a structure of cutting guide for table saw. The structure of cutting guide is provided on the worktable of table saw, with an appropriate distance is kept between the cutting guide and saw blade. The structure of cutting guide includes a alignment body, which has an accommodating space provided therein, and a pair of tracks corresponding to each other with front-and-back locations is provided inside the accommodating space for being mounted by an adjusting plate. The adjusting plate can be position-adjusted along the tracks. Besides, a mark is longitudinally provided on the adjusting plate, while a transparent cover is provided at the upper side of alignment body. Therefore, when cutting operation is performed on a workpiece, a referential baseline can be provided, so that the workpiece can be aligned with the saw blade through the referential baseline and ready for cutting.

### FIELD OF THE INVENTION

The invention relates to a guiding structure for a table saw and, more particularly, to a structure of cutting guide applied for measuring and aligning a workpiece so that the workpiece can be aligned with the saw blade for cutting operation.

### BACKGROUND OF THE INVENTION

Referring to FIG. 1, a common table saw provides a miter gauge (not shown) at one lateral side of table saw to help a workpiece move forward and push the workpiece toward the saw blade 1 for cutting. Technically, before cutting operation, the cutting line drawn for cutting against the workpiece has to be aligned with the saw blade 1 so that the workpiece can be cut precisely. However, in real cutting operation, an appropriate safety distance must be kept between the workpiece and saw blade 1, and because of the distance, a deviation is likely to occur between the cutting line and saw blade 1 when an operator is performing aligning job with the eyes. To solve the deviation problem, a method that allows the workpiece to be aligned with the saw blade 1 is disclosed. The method is to provide a noumenon 2 located at the front side of workpiece and lower than the table top of table saw. Then, by using a pencil on the noumenon 2, the operator can draw a referential baseline 3 aligned with the saw blade 1. By doing so, the cutting line, against which the workpiece will be cut, can be done with measuring alignment through referential baseline 3 of noumenon 2 so as to facilitate precise cutting when the workpiece is moved toward the saw blade 1. However, in spite of improvement disclosed by the above-mentioned method, cutting requirements of various workpiece may still vary, which in turn may require different specifications of saw blade 1 to comply with the requirements. Consequently, the operator has to remake a new referential baseline 3 on noumenon 2 every time when a specific cutting requirement is needed for a specific workpiece. Besides, the referential baseline 3 is liable to be covered and blurred by wood dust generated during cutting process, or the situation may be that the referential baseline 3 can be smeared when the operator is cleaning wood dust with his/her hand.

In view of the foregoing problems, the inventor of the present invention has come up with a solution that can fully improve the drawbacks of prior arts.

### SUMMARY OF THE INVENTION

The object of the invention is to provide a structure of cutting guide for table saw on the worktable of table saw with a location that is in between the front side of saw blade and front rim of worktable, and an appropriate distance is kept between the cutting guide and the front side of saw blade; when in operation, first, the mark of adjusting plate inside the alignment body could be adjusted so as to find an-alignment with the saw blade and then fix the aligned position. Next, when a workpiece is mounted on top of worktable of table saw, the cutting line of workpiece will be aligned with the mark of adjusting plate so that the workpiece can be cut precisely.

The object and technical contents of the invention will be better understood through descriptions of the following embodiment with reference to the drawings.

### BRIEF DESCRIPTION OF THE DRAWINGS

FIG. 1 is a perspective schematic diagram illustrating a conventional table saw.

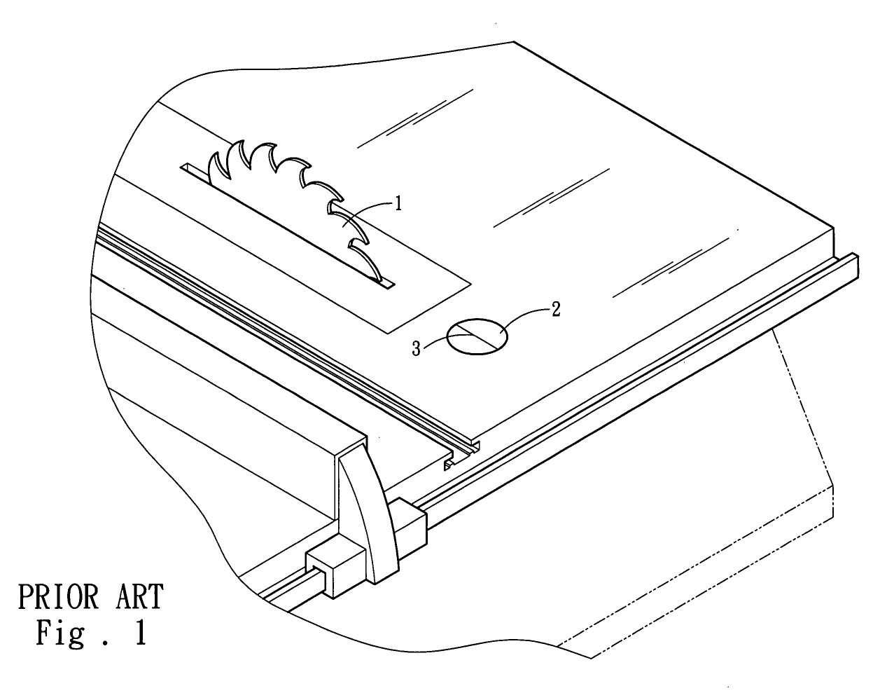

FIG. 2A is a perspective diagram illustrating the invention is provided on the table saw.

FIG. 2B is a sectional view of an embodiment of the invention.

FIG. 3 is an exploded view of the embodiment of the invention.

### DETAILED DESCRIPTION OF THE PREFERRED EMBODIMENTS

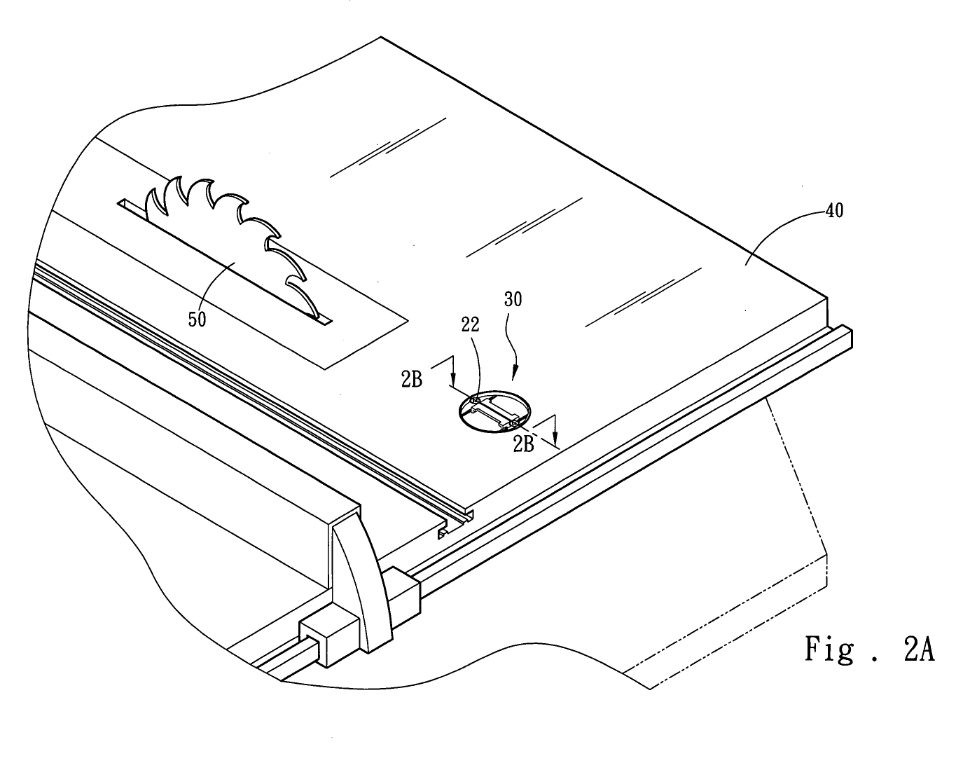

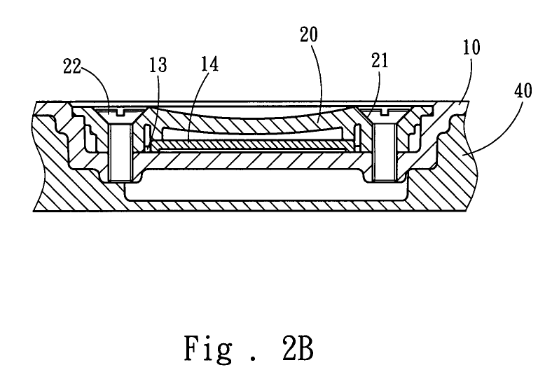

Referring to FIG. 2A, the structure of cutting guide 30 for table saw of the invention is provided on the worktable 40 of table saw between the front side of saw blade 50 and front rim of worktable 40, and an appropriate distance is kept between the cutting guide 30 and the front side of saw blade 50.

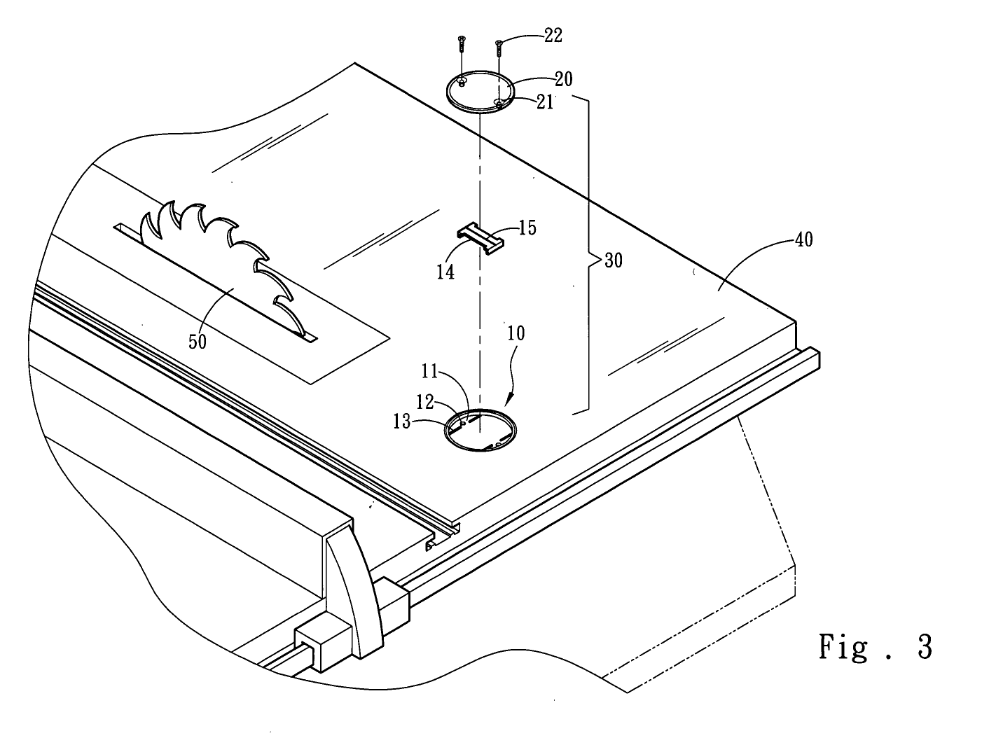

Also, referring to FIGS. 2B and 3, the structure of cutting guide 30 further includes:
an alignment body 10, which has an accommodating space 11 provided therein, wherein a through hole 12 is separately provided at the front side and rear side of accommodating space 11, and a pair of tracks 13 are provided in parallel on both the front and rear sides; besides, an adjusting plate 14 is mounted in parallel with the two tracks 13, and a mark 15 in straight line is provided longitudinally in the middle of adjusting plate 14; and
a transparent cover 20, which has a hole 21 provided thereon, wherein the hole 21 is corresponding to the through hole 12 of alignment body 10 and can be penetrated by a connecting member 22 (such as a screw); the connecting member 22 can be screwed on the through hole 12 of accommodating space 11, and then the cover 20 can be joined to the alignment body 10; also, the adjusting plate 14 inside the alignment body 10 can be sealed and fastened so that the adjusting plate 14 can be prevented from shifting when vibrations are generated by table saw during operation; moreover, the top surface of cover 20 is lower than that of worktable 40 of table saw so that movement of workpiece cannot be hindered.

Through the foregoing structure, the adjusting plate 14 inside the alignment body 10 will be position-adjusted first when in operation so that the mark 15 on the adjusting plate 14 can be aligned with the saw blade 50. Next, place the cover 20 onto the top of alignment body 10, and through the connecting member 22, the cover 20 can be connected to the top of alignment body 10. Then, when the workpiece is mounted on the surface of worktable 40 of table saw, the cutting line against the workpiece can be aligned with the mark 15 of adjusting plate 14. Finally, when the workpiece is moved ahead toward the saw blade 50, the cutting line against the workpiece can be aligned with the saw blade 50 to facilitate precise cutting on the workpiece.

1. A structure of cutting guide for table saw, which is provided on a worktable of table saw between a front side of saw blade and a front rim of worktable, and an appropriate distance is kept between the cutting guide and the front side of saw blade, wherein the structure of cutting guide includes:
an alignment body, which has an adjusting plate provided therein, and the adjusting plate can be adjusted inside the alignment body; besides, a mark is provided on the adjusting plate; and
a transparent cover, which is provided on top of the alignment body to cover the alignment body;

2. The structure of cutting guide for table saw as claimed in claim 1, wherein an accommodating space is provided in the alignment body, and a pair of tracks is provided correspondingly in the accommodating space, wherein the tracks are to be mounted by the adjusting plate.

3. The structure of cutting guide for table saw as claimed in claim 1, wherein at least one through hole is provided in the accommodating space of the alignment body, and a hole is provided on the cover corresponding to the through hole on the alignment body and connectable to a connecting member.
